(19) United States
(12) Patent Application Publication
(10) Pub. No.: US 2018/0167753 A1
(43) Pub. Date: Jun. 14, 2018

(54) AUDIO MONITORING AND ADAPTATION USING HEADSET MICROPHONES INSIDE USER'S EAR CANAL

(71) Applicant: Knowles Electronics, LLC, Itasca, IL (US)

(72) Inventors: Kuan-Chieh Yen, Foster City, CA (US); Thomas E. Miller, Arlington Heights, IL (US)

(73) Assignee: Knowles Electronics, LLC, Itasca, IL (US)

(21) Appl. No.: 15/892,153

(22) Filed: Feb. 8, 2018

Related U.S. Application Data
(62) Division of application No. 14/985,187, filed on Dec. 30, 2015.

(51) Int. Cl. H04R 29/00; H04R 1/10; H04R 3/04

(52) U.S. Cl. CPC H04R 29/001; H04S 2420/01; H04R 2460/05; H04R 2460/01; H04R 2201/107; H04R 1/1041; H04R 3/04; H04R 2460/15; H04R 2430/01; H04R 1/1083; H04R 1/1016

(57) ABSTRACT

Systems and methods for audio monitoring and adaptation are provided. An example method includes monitoring an acoustic signal, representing at least one captured sound, inside at least one ear canal. The captured sound includes an audio for play back inside the ear canal. The acoustic signal can be analyzed to determine perceptual parameters including level of the acoustic signal, duration of the acoustic signal, inter-aural time difference (ITD), inter-aural level difference (ILD), seal quality, and environmental noise estimate. Based on the perceptual parameters, the played back audio is adapted to improve quality thereof. The adaptation includes regulating the volume of the acoustic signal, performing noise-dependent gain control on the acoustic signal, performing inter-aural temporal alignment and spectral equalization, and equalizing an acoustic response inside the ear canal.

### CROSS-REFERENCE TO RELATED APPLICATIONS

The present application is a divisional of U.S. patent application Ser. No. 14/985,187 filed Dec. 30, 2015, the contents of which are incorporated herein by reference in their entirety.

### FIELD

The present application relates generally to audio processing and, more specifically, to systems and methods for audio monitoring and adaptation using headset microphones inside a user's ear canals.

### BACKGROUND

Headsets are used primarily for listening to audio content (for example, music) and hands-free telephony. A user's audio experience in both of these exemplary cases needs to meet a certain quality. Many factors can affect the quality of the user's audio experience. These factors can include, for example, the electro-acoustical response of the audio reproduction system, the fitting and sealing conditions of the earpieces in the user's ears, and environmental noise. In addition, the widespread usage of headsets can also raise concerns regarding the health impact on a user's auditory system.

Known systems for noise control and equalization (EQ) use simple gain control that applies the same gain to all frequencies, which is often inefficient and not necessary. These systems may include frequency-dependent gains to boost the signal over a noise masking threshold. This could lead to excess power consumption, increased nonlinear distortion, and heightened risk of hearing damage.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Systems and methods for audio monitoring and adaptation are provided. In various embodiments, an example method includes monitoring an acoustic signal. The acoustic signal can include at least one sound captured inside at least one ear canal. The captured sound includes at least an audio content for play back inside the at least one ear canal. The method may analyze the acoustic signal to determine at least one perceptual parameter. The method can also adapt, based on the perceptual parameters, the audio content for play back inside the at least one ear canal.

In some embodiments, the perceptual parameters include a level of the acoustic signal and a duration of the acoustic signal. In certain embodiments, if the level of the acoustic signal exceeds a pre-determined level for a pre-determined duration, the method can provide a warning notification to a user and/or adjust a volume of the audio content.

In various embodiments, the perceptual parameters include an inter-aural time difference (ITD) and/or an inter-aural level difference (ILD). The method may include performing, based on the ITD and the ILD, an inter-aural temporal alignment and spectral equalization of the audio content.

In other embodiments, the perceptual parameters include an estimation of seal quality of at least one earpiece in the at least one ear canal. In certain embodiments, if the acoustic sealing is below a pre-determined threshold, the method allows providing a notification for suggesting an adjustment of the at least one earpiece in the at least one ear canal and/or applying an adaptive filter to the audio content to equalize an acoustic response inside the at least one ear canal.

In some embodiments, the perceptual parameters include a noise estimate inside the ear canal. The method can further include providing a time-varying noise masking threshold curve and a pain threshold curve. The method may apply a time-varying frequency-dependent gain to the audio content to increase a level of the audio content above the noise masking threshold curve if the increased level is below the pain threshold curve.

According to other example embodiments of the present disclosure, the steps of the method for audio monitoring and adaptation are stored on a non-transitory machine-readable medium comprising instructions, which, when implemented by one or more processors, perform the recited steps.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 is a block diagram of a system and an environment in which the system is used, according to an example embodiment.

FIG. 2 is a block diagram of a headset suitable for implementing the present technology, according to an example embodiment.

FIG. 3 is a block diagram illustrating a system for providing audio monitoring and adaptation, according to an example embodiment.

FIG. 4 is a flow chart showing steps of a method for providing audio monitoring and adaptation, according to an example embodiment.

FIG. 5 illustrates an example of a computer system that may be used to implement embodiments of the disclosed technology.

### DETAILED DESCRIPTION

The present technology provides systems and methods for audio monitoring and adaptation, which can overcome or substantially alleviate problems associated with the quality of a user's audio perception when listening to audio using headsets. Embodiments of the present technology may be practiced with any earpiece-based audio device that is configured to receive and/or provide audio such as, but not limited to, cellular phones, MP3 players, phone handsets, hearing aids, and headsets. The audio device may have one or more earpieces. While some embodiments of the present technology are described in reference to operation of a cellular phone, the present technology may be practiced with any audio device.

Microphones inside user's ear canals can be used to monitor parameters of an audio played back inside the ear canals. The monitored parameters can include sound exposure, acoustic sealing of the ear canals, noise estimates inside the ear canals, an inter-aural time difference, and an inter-aural level difference. In various embodiments, the monitored parameters are used to improve the quality of the played back audio by regulating volume and time of the audio, applying noise-dependent gain mask, equalizing the in-ear-canal acoustic response, and performing binaural alignment and equalization.

According to an example embodiment, a method for audio monitoring and adaptation includes monitoring an acoustic signal. The acoustic signal can include at least one sound captured inside at least one ear canal. The captured sound can include at least an audio content for play back inside the ear canal. The method further allows analyzing the acoustic signal to determine at least one perceptual parameter. The method can then proceed to adapt, based on the at least one perceptual parameter, the audio content for play back inside the at least one ear canal.

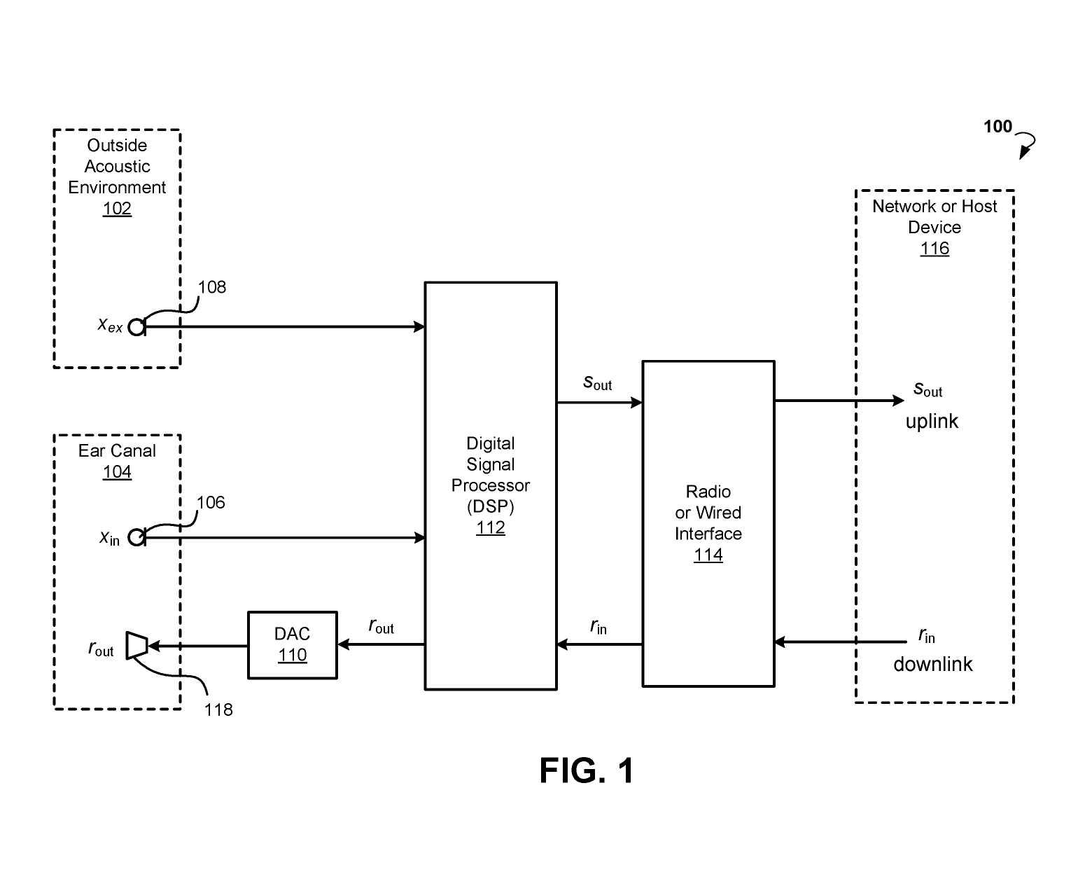

Referring now to FIG. 1, a block diagram of an example system 100 for monitoring and adapting audio and environment thereof is shown. The example system 100 can include at least an internal microphone 106, an external microphone 108, a digital signal processor (DSP) 112, and a radio or wired interface 114. The internal microphone 106 is located inside a user's ear canal 104 and is relatively shielded from the outside acoustic environment 102. The external microphone 108 is located outside the user's ear canal 104 and is exposed to the outside acoustic environment 102.

In various embodiments, the microphones 106 and 108 are either analog or digital. In either case, the outputs from the microphones are converted into a synchronized pulse code modulation (PCM) format at a suitable sampling frequency and connected to the input port of the DSP 112. The signals xᵢₙ and xₑₓ denote signals representing sounds captured by the internal microphone 106 and external microphone 108, respectively.

The DSP 112 performs appropriate signal processing tasks to improve the quality of microphone signals xᵢₙ and xₑₓ, according to some embodiments. The output of DSP 112, referred to as the send-out signal (sₒᵤₜ), is transmitted to the desired destination, for example, to a network or host device 116 (see signal identified as sₒᵤₜ uplink), through a radio or wired interface 114.

In certain embodiments, if a two-way voice communication is needed, a signal is received by the network or host device 116 from a suitable source (e.g., via the radio or wired interface 114). This is referred to as the receive-in signal (rᵢₙ) (identified as rᵢₙ downlink at the network or host device 116). The receive-in signal can be coupled via the radio or wired interface 114 to the DSP 112 for processing. The resulting signal, referred to as the receive-out signal (signal rₒᵤₜ), is converted into an analog signal through a digital-to-analog convertor (DAC) 110 and then connected to a loudspeaker 118 in order to be presented to the user. In some embodiments, a loudspeaker 118 may be located in the same ear canal 104 as the internal microphone 106, and/or in the opposite ear canal. In the example of FIG. 1, there is both a loudspeaker 118 and the internal microphone 106 in the ear canal 104, therefore, an acoustic echo canceller (AEC) may be needed to prevent the feedback of the received signal to the other end. Optionally, if no further processing of the received signal is necessary, the receive-in signal (rᵢₙ) can be coupled to the loudspeaker without going through the DSP 112. In some embodiments, the receive-in signal rᵢₙ played by loudspeaker 118 (and loudspeaker in the opposite ear canal) can include an audio content (also referred to herein as an audio), for example, music and speech.

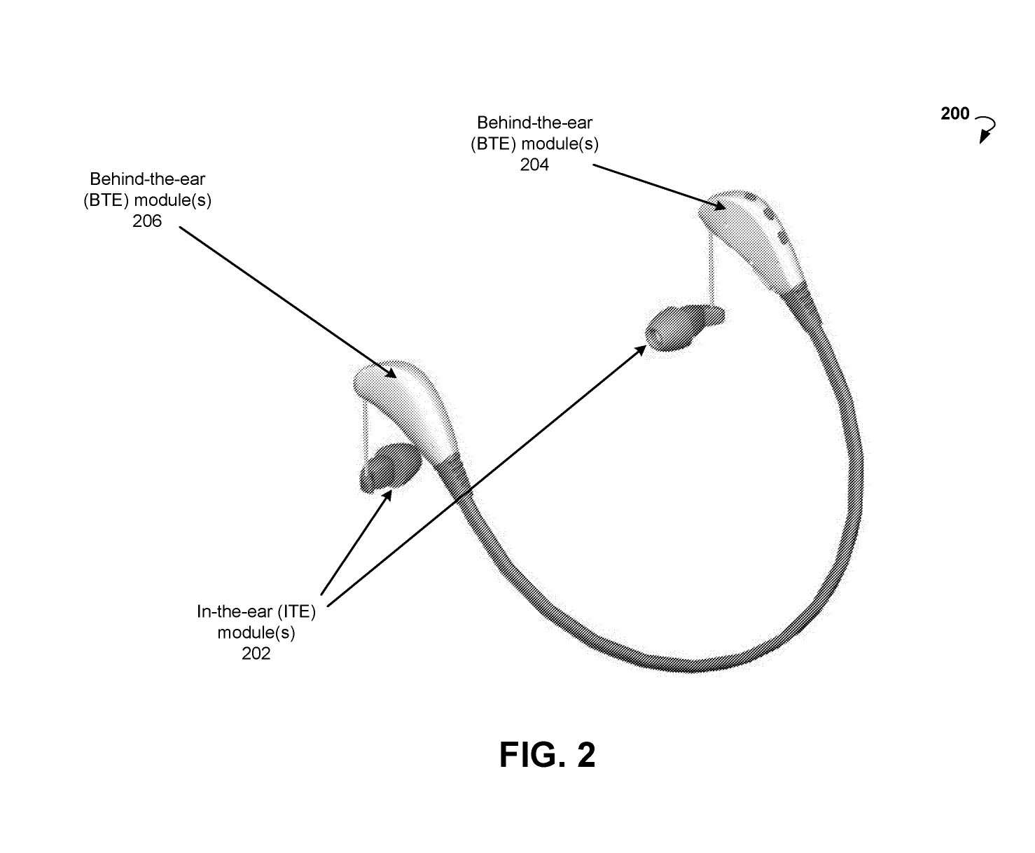

FIG. 2 shows an example headset 200 suitable for implementing methods of the present disclosure. The headset 200 can include example in-the-ear (ITE) module(s) 202 and behind-the-ear (BTE) modules 204 and 206 for each ear of a user, respectively. The ITE module(s) 202 can be configured to be inserted into the user's ear canals. The BTE modules 204 and 206 are configured to be placed behind (or otherwise near) the user's ears. In some embodiments, the headset 200 communicates with host devices through a wireless radio link. The wireless radio link may conform to the Bluetooth Low Energy (BLE), other Bluetooth, 802.11, or other suitable standard and may be variously encrypted for privacy.

In various embodiments, ITE module(s) 202 include internal microphone(s) 106 and the loudspeaker(s) 118 (shown in FIG. 1), all facing inward with respect to the ear canal 104. The ITE module(s) 202 can provide acoustic isolation between the ear canal(s) 104 and the outside acoustic environment 102 (also shown in FIG. 1).

In some embodiments, each of the BTE modules 204 and 206 includes at least one external microphone. The BTE module 204 may include a DSP 112 (as shown in FIG. 1), control button(s), and Bluetooth radio link to host devices. The BTE module 206 can include a suitable battery with charging circuitry.

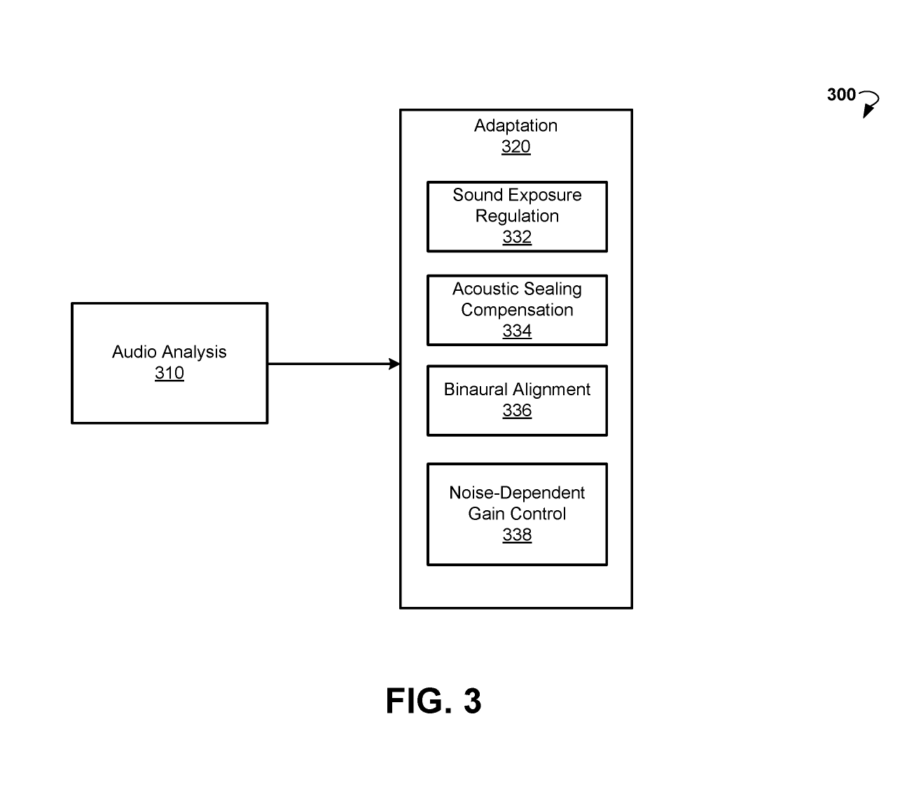

FIG. 3 is a block diagram of a system 300 for providing audio monitoring and adaptation, according to an example embodiment. The illustrated system 300 includes an audio analysis module 310 and an adaptation module 320. In some embodiments, the adaptation module 320 includes a sound exposure regulation module 332, an acoustic sealing compensation module 334, binaural alignment module 336, and noise-dependent gain control module 338. The modules of system 300 can be implemented as instructions stored in a memory and executed by either DSP 112 or at least one processor of network or host device 116 (as shown in FIG. 1).

In some embodiments, audio analysis module 310 is operable to receive signal xᵢₙ captured by internal microphone 106 in ear canal 104. In further embodiments, audio analysis module 310 receives signals captured by internal microphones inside both ear canals (the ear canal 104 and the ear canal opposite the ear canal 104). The captured signals can include an audio (signal rₒᵤₜ) played back by the loudspeakers inside the ear canals. The captured signals may also include an environmental noise permeating inside the ear canals from the outside acoustic environment 102. The received signals can then be analyzed to obtain listening parameters, including but not limited to sound exposure, acoustic sealing of an ear canal, inter-aural time difference (ITD) and inter-aural level difference (ILD) of signals captured in opposite ear canals, noise estimates inside the ear canals, and so forth.

In various embodiments, the sound exposure regulation module 332 is operable to adapt at least the volume of audio played back inside the ear canal. The adaptation can be based on a sound exposure. The sound exposure may be a function of both a level of the sound and a duration of the sound, to which the auditory system of the headset user is subjected. The duration of the safe usage of the headset is shorter for a louder sound played by the loudspeakers. In some embodiments, the sound exposure of the user is estimated based on signals captured by the internal microphones. In some embodiments, based on the user's sound exposure, the sound exposure regulation module 332 is operable to provide, via loudspeakers of the headsets, a warning to the user, for example a voice message, a specific signal, a text message, and so forth. In other embodiments, the sound exposure regulation module 332 is operable to limit or regulate the volume of audio played back by the loudspeakers of the headsets or usage time of the headsets.

The sealing condition of an earpiece in a user's ear has a significant impact on acoustic response inside the user's ear canal. When the acoustic leakage increases, the acoustic energy inside the user's ear canal drops, especially at a low frequency range. As a result, both loudness and spectral balance perceived by the user of the headset depend on the acoustic sealing condition. Because the signal rₒᵤₜ sent to the headset's loudspeakers is known, the acoustic response inside the user's ear canal can be estimated based on signal xᵢₙ captured by the internal microphone. In some embodiments, the signal captured by the internal microphone is used passively to detect that acoustic sealing is below a pre-determined threshold. In certain embodiments, in response to the determination that the acoustic sealing is below a pre-determined threshold, acoustic sealing compensation module 334 is operable to suggest to the user to make adjustments to the earpieces. In other embodiments, acoustic sealing compensation module 334 is operable to use an adaptive filter to equalize the acoustic response inside the ear canal to minimize variations perceived by the user. An example system and method suitable for detecting and compensating for seal quality is discussed in more detail in U.S. patent application Ser. No. 14/985,057, entitled “Occlusion Reduction and Active Noise Reduction Based on Seal Quality”, filed Dec. 30, 2015, now U.S. Pat. No. 9,779,716 the disclosure of which is incorporated herein by reference for all purposes.

While measurements of leaks in the seal of the earpiece can be made using naturally occurring sounds, these sounds may not have sufficient energy in the low frequency region to allow a quick and accurate measurement of the leak. By applying a test signal, the system can more quickly assess any leaks. The test signal can be played at various times, such as when the headset is first put on before any other activities have started, or any time the user or possibly the headset itself decides a recalibration of the system might be needed. The test signal might be played when no other sound is being played, or may be able to be used simultaneously and unobtrusively at the same time other sounds are being played through the headset. Test signals whose spectral content includes only low frequency energy will be less obtrusive to the user. Signals for testing may include a steady sine wave tone, a mixture of several steady tones, a continuously or incrementally stepped sine tone sweep, or random or pseudo-random noise, including the binary pseudo-random noise signal known as a Maximum Length Sequence (MLS). The MLS signal is particularly well suited for testing at the same time as other audio signals are present, and enables simpler calculations to be used to obtain the measurement results.

In various embodiments, for binaural headsets, the perceived sound field is primarily decided by the ITD and the ILD. Therefore, the temporal and spectral inter-aural mismatch due to the differences in acoustic sealing or electro-acoustic components between the left and right ears result in distortion of the perceived sound field. In some embodiments, based on the signals sent to and played back by the loudspeakers of both earpieces, delays and responses of the played back signals at both ear canals are estimated using the signals captured by the internal microphones in the corresponding ear canals. The delays and responses represent estimates for the ITD and the ILD. In other embodiments, the binaural alignment module 336 is operable to perform, based on the estimates of the ITD and the ILD, inter-aural temporal alignment and spectral equalization.

The presence of environmental noise can have a masking effect on the audio (music or speech) presented by the headset loudspeakers, and thus, degrades the quality and intelligibility perceived by the headset user. The noise masking effect can be represented by a time-varying noise masking threshold curve that indicates the minimum level at each frequency that can be perceived under a particular noise condition. On the other hand, there exists a pain threshold curve that indicates the level at each frequency above which a user (listener) would feel pain and audio may not be perceived effectively. Increased noise levels push up the noise masking threshold, and thus, compress the user's audio dynamic range represented by the space between the two curves.

In some embodiments, noise inside the ear canal can be estimated based on signal xin captured by the internal microphone. The estimates for the noise are then used to determine a current noise masking threshold. Additionally, in some embodiments, the spectral distribution of audio (for example, music or speech) played back by the loudspeaker in the ear canal is estimated based on the signal captured by the internal microphone signal. In further embodiments, the noise-dependent gain control module 338 is operable to apply a time-varying, frequency-dependent gain to the signal played by the loudspeaker to boost the signal above the noise masking threshold, if there is room below the pain threshold. In certain embodiments, the time-varying, frequency-dependent gain is applied to de-emphasize the signal in the frequency range in which the audio dynamic range is lost. By way of example and not limitation, noise suppression methods are also described in more detail in U.S. patent application Ser. No. 12/832,901 (now U.S. Pat. No. 8,473,287), entitled “Method for Jointly Optimizing Noise Reduction and Voice Quality in a Mono or Multi-Microphone System,” filed Jul. 8, 2010, and U.S. patent application Ser. No. 11/699,732 (now U.S. Pat. No. 8,194,880), entitled “System and Method for Utilizing Omni-Directional Microphones for Speech Enhancement,” filed Jan. 29, 2007, the disclosures of which is incorporated herein by reference for all purposes. Another system for digital signal processing is described in more detail in U.S. Provisional Patent Application 62/088,072, entitled “Apparatus and Method for Digital Signal Processing with Microphones,” filed Dec. 5, 2014.

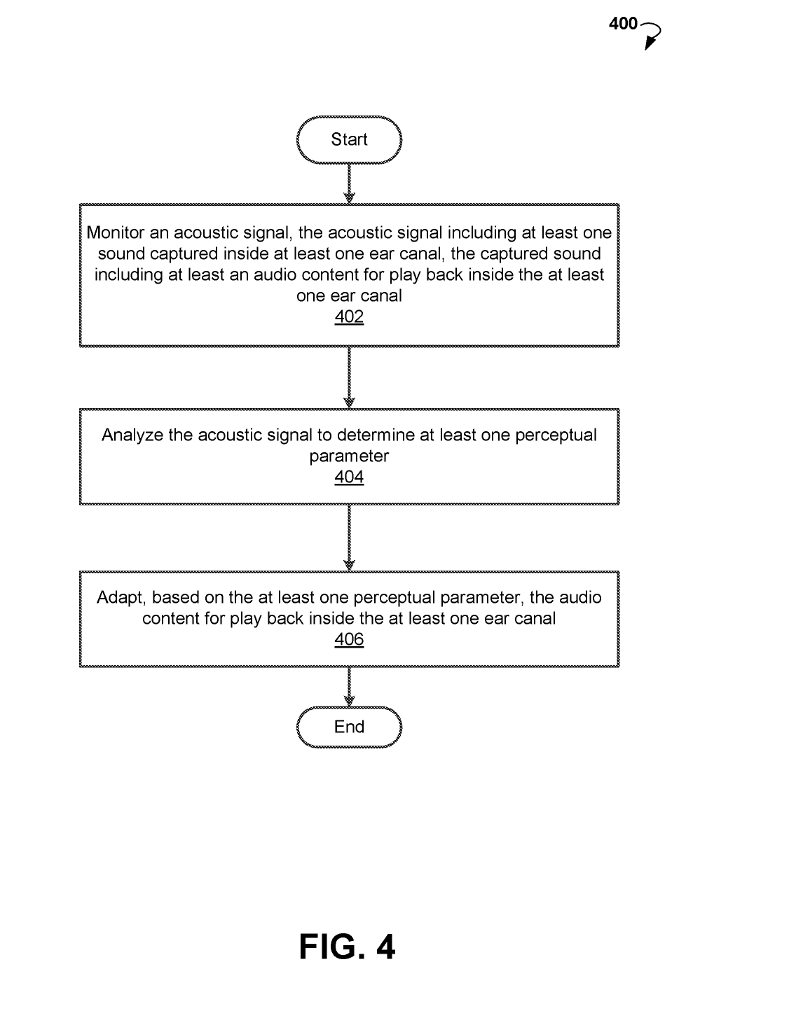

FIG. 4 is a flow chart showing steps of method 400 for audio monitoring and adaptation, according to various example embodiments. The example method 400 can commence with monitoring an acoustic signal in block 402. The acoustic signal includes at least one sound captured inside at least one ear canal. The captured sound includes at least an audio content for play back inside the ear canal.

In block 404, example method 400 proceeds with analyzing the acoustic signal to determine at least one perceptual parameter. In various embodiments, the perceptual parameter includes level of the acoustic signal, duration of the acoustic signal, ITD, ILD, acoustic sealing of the ear canal, noise estimate inside the ear canal, and so forth.

In block 406, the example method 400 allows adapting, based on the at least one perceptual parameter, the audio content for play back inside the ear canal to improve quality thereof.

In some embodiments, if the level of the acoustic sound exceeds a pre-determined value for a pre-determined time period, the adaptation includes regulating the volume of the audio content.

In certain embodiments, the adaptation includes performing a noise-dependent gain control on the audio content. A time-varying noise masking threshold curve and a pain threshold curve can be provided, according to some embodiments. A time-varying gain, which may be frequency-dependent, can be then applied to the audio content to increase a level of the audio content above the noise masking threshold curve if the increased level is still below the pain threshold curve.

In some embodiments, the adaptation includes performing, based on the ITD and the ILD, inter-aural temporal alignment and spectral equalization. In various embodiments, if the acoustic sealing is below a pre-determined threshold, the adaptation includes equalizing an acoustic response inside the ear canal. In certain embodiments, an adaptive filter can be applied to the audio content to equalize the acoustic response inside the ear canal.

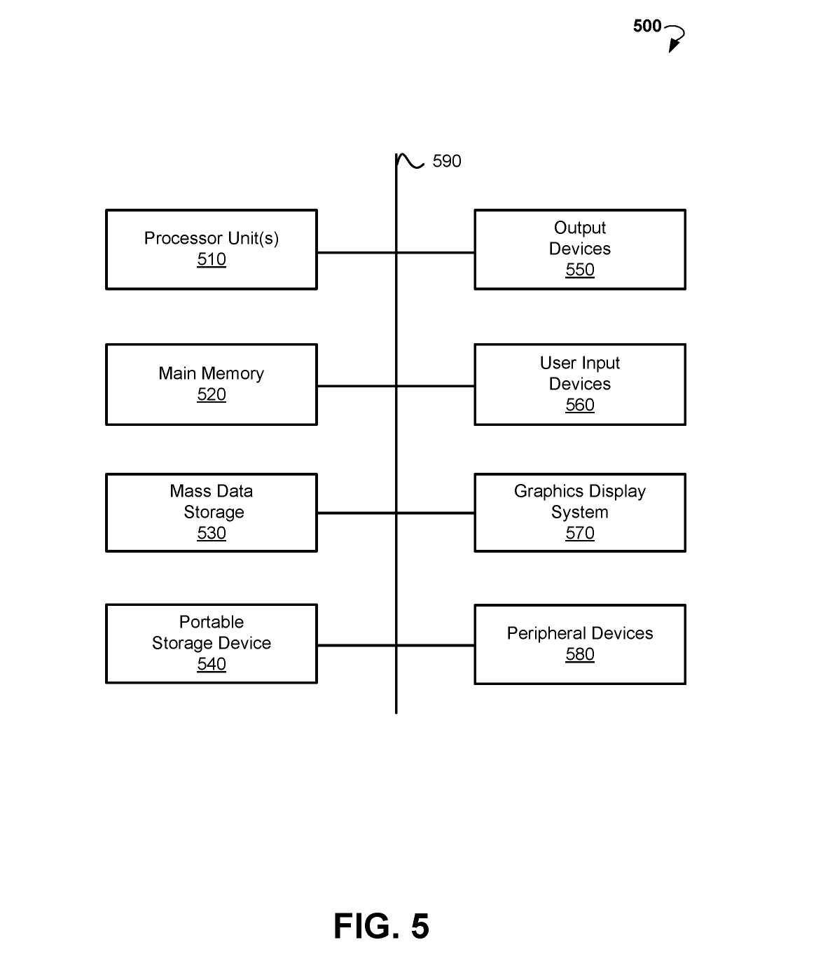

FIG. 5 illustrates an exemplary computer system 500 that may be used to implement some embodiments of the present invention. The computer system 500 of FIG. 5 may be implemented in the contexts of the likes of computing systems, networks, servers, or combinations thereof. The computer system 500 of FIG. 5 includes one or more processor units 510 and main memory 520. Main memory 520 stores, in part, instructions and data for execution by processor unit(s) 510. Main memory 520 stores the executable code when in operation, in this example. The computer system 500 of FIG. 5 further includes a mass data storage 530, portable storage device 540, output devices 550, user input devices 560, a graphics display system 570, and peripheral devices 580.

The components shown in FIG. 5 are depicted as being connected via a single bus 590. The components may be connected through one or more data transport means. Processor unit(s) 510 and main memory 520 is connected via a local microprocessor bus, and the mass data storage 530, peripheral device(s) 580, portable storage device 540, and graphics display system 570 are connected via one or more input/output (I/O) buses.

Mass data storage 530, which can be implemented with a magnetic disk drive, solid state drive, or an optical disk drive, is a non-volatile storage device for storing data and instructions for use by processor unit(s) 510. Mass data storage 530 stores the system software for implementing embodiments of the present disclosure for purposes of loading that software into main memory 520.

Portable storage device 540 operates in conjunction with a portable non-volatile storage medium, such as a flash drive, floppy disk, compact disk, digital video disc, or Universal Serial Bus (USB) storage device, to input and output data and code to and from the computer system 500 of FIG. 5. The system software for implementing embodiments of the present disclosure is stored on such a portable medium and input to the computer system 500 via the portable storage device 540.

User input devices 560 can provide a portion of a user interface. User input devices 560 may include one or more microphones, an alphanumeric keypad, such as a keyboard, for inputting alphanumeric and other information, or a pointing device, such as a mouse, a trackball, stylus, or cursor direction keys. User input devices 560 can also include a touchscreen. Additionally, the computer system 500 as shown in FIG. 5 includes output devices 550. Suitable output devices 550 include speakers, printers, network interfaces, and monitors.

Graphics display system 570 includes a liquid crystal display (LCD) or other suitable display device. Graphics display system 570 is configurable to receive textual and graphical information and processes the information for output to the display device.

Peripheral devices 580 may include any type of computer support device to add additional functionality to the computer system.

The components provided in the computer system 500 of FIG. 5 are those typically found in computer systems that may be suitable for use with embodiments of the present disclosure and are intended to represent a broad category of such computer components that are well known in the art. Thus, the computer system 500 of FIG. 5 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

The processing for various embodiments may be implemented in software that is cloud-based. In some embodiments, the computer system 500 is implemented as a cloud-based computing environment, such as a virtual machine operating within a computing cloud. In other embodiments, the computer system 500 may itself include a cloud-based computing environment, where the functionalities of the computer system 500 are executed in a distributed fashion. Thus, the computer system 500, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 500, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

The present technology is described above with reference to example embodiments. Therefore, other variations upon the example embodiments are intended to be covered by the present disclosure.

What is claimed is:

1. A method comprising:
monitoring an acoustic signal, the acoustic signal including sound captured inside an ear canal, the captured sound including audio content being played back inside the at least one ear canal and noise within the ear canal;
analyzing the acoustic signal to determine a noise estimate of the noise within the ear canal; and
adapting, based on the noise estimate, the audio content for play back inside the at least one ear canal.

2. The method of claim 1, wherein adapting includes:
determining, based on the noise estimate, a noise masking threshold that indicates a minimum volume below which the audio content cannot be perceived due to the noise; and
using the noise masking threshold to adjust a playback volume of the audio content above the noise masking threshold.

3. The method of claim 2, wherein the noise masking threshold is time-varying.

4. The method of claim 2, wherein the noise masking threshold is frequency-dependent.

5. The method of claim 1, wherein adapting includes:
determining, based on the noise estimate, a noise masking threshold for a plurality of different frequencies that indicates a minimum volume for each of the plurality of different frequencies below which the audio content cannot be perceived due to the noise; and
using the noise masking threshold to adjust a playback volume of the audio content above the noise masking threshold at the plurality of different frequencies.

6. The method of claim 5, further comprising determining the playback volume of the audio content based on the captured sound.

7. The method of claim 2, wherein adapting further includes:
identifying a pain threshold for the audio content above which a listener would feel pain; and
preventing the playback volume of the audio content from being adjusted above the pain threshold.

8. The method of claim 5, wherein adapting further includes:
identifying a pain threshold for the audio content above which a listener would feel pain for the plurality of different frequencies; and
preventing the playback volume of the audio content at the plurality of different frequencies from being adjusted above the pain threshold.

9. The method of claim 1, wherein the noise within the ear canal comprises noise from outside the ear canal permeating into the ear canal.

10. A system comprising:
a processor; and
a memory communicatively coupled with the processor, the memory storing instructions which, when executed by the processor, perform a method comprising:
monitoring an acoustic signal, the acoustic signal including sound captured inside an ear canal, the captured sound including audio content being played back inside the at least one ear canal and noise within the ear canal;
analyzing the acoustic signal to determine a noise estimate of the noise within the ear canal; and
adapting, based on the noise estimate, the audio content for play back inside the at least one ear canal.

11. The system of claim 10, wherein adapting includes:
determining, based on the noise estimate, a noise masking threshold that indicates a minimum volume below which the audio content cannot be perceived due to the noise; and
using the noise masking threshold to adjust a playback volume of the audio content above the noise masking threshold.

12. The system of claim 11, wherein the noise masking threshold is time-varying.

13. The system of claim 11, wherein the noise masking threshold is frequency-dependent.

14. The system of claim 10, wherein adapting includes:
determining, based on the noise estimate, a noise masking threshold for a plurality of different frequencies that indicates a minimum volume for each of the plurality of different frequencies below which the audio content cannot be perceived due to the noise; and
using the noise masking threshold to adjust a playback volume of the audio content above the noise masking threshold at the plurality of different frequencies.

15. The system of claim 14, wherein the method further comprises determining the playback volume of the audio content based on the captured sound.

16. The system of claim 11, wherein adapting further includes:
identifying a pain threshold for the audio content above which a listener would feel pain; and
preventing the playback volume of the audio content from being adjusted above the pain threshold.

17. The system of claim 14, wherein adapting further includes:
identifying a pain threshold for the audio content above which a listener would feel pain for the plurality of different frequencies; and
preventing the playback volume of the audio content at the plurality of different frequencies from being adjusted above the pain threshold.

18. The system of claim 10, wherein the noise within the ear canal comprises noise from outside the ear canal permeating into the ear canal.

19. A non-transitory computer-readable storage medium having embodied thereon instructions, which, when executed by at least one processor, perform steps of a method, the method comprising:
monitoring an acoustic signal, the acoustic signal including sound captured inside an ear canal, the captured sound including audio content being played back inside the at least one ear canal and noise within the ear canal;
analyzing the acoustic signal to determine a noise estimate of the noise within the ear canal; and
adapting, based on the noise estimate, the audio content for play back inside the at least one ear canal.
